(19) United States
(12) Patent Application Publication
(10) Pub. No.: US 2013/0198066 A1
(43) Pub. Date: Aug. 1, 2013

(54) Fraud Protection for Online and NFC Purchases

(71) Applicants: Jonathan Wall, San Francisco, CA (US); Rob von Behren, Berkeley, CA (US); Andy Nowka, Mountain View, CA (US)

(72) Inventors: Jonathan Wall, San Francisco, CA (US); Rob von Behren, Berkeley, CA (US); Andy Nowka, Mountain View, CA (US)

(73) Assignee: GOOGLE Inc., Mountain View, CA (US)

(21) Appl. No.: 13/360,098

(22) Filed: Jan. 27, 2012

(51) Int. Cl. G06Q 20/40; H04B 5/00; G06Q 20/32; G06Q 20/36

(52) U.S. Cl. 705/41; 705/44

(57) ABSTRACT

A fraud protection application can allow a user to safely purchase goods without a physical account verifier such as a credit card. These types of purchases are common when purchasing items online and also when making NFC purchases. The purchaser can install a Fraud Prevention Application on a device that can recognize that the purchaser is using their device to make a purchase making a transaction. The application can initiate an independent connection with the financial institution's server and submit to the server verification data to validate the purchase. In response, the server can compare the data with identification data previously submitted by that purchaser's device and also with transaction data submitted by the merchant. If the verification data is validated then the server can approve the purchase and the transaction may proceed. If the verification data is not validated then the FPA can cause refuse the transaction.

### TECHNICAL FIELD

The present disclosure relates generally to electronic commerce, and more particularly to a method for protecting an online or near field communication purchase from fraud.

### BACKGROUND

Electronic commerce, such as online shopping, has been increasingly common since the advent of the Internet. Online shopping websites generally provide a user interface for customers to select products to purchase. After the customer has selected products for purchase, the customer typically can choose from multiple payment options to purchase the products. One conventional payment option generally supported by online merchants is the use of a financial account. Commonly, a credit card account or checking account is employed for such a purchase.

More recently, physical merchant locations have taken advantage of the increasingly sophisticated mobile devices employed by their customers. Instead of purchasing products through the use of a physical credit card, the customer's mobile device may transmit the payment information to the merchant's point of sale terminal via a wireless link. This link is commonly referred to as Near Field Communication (“NFC”).

Both online purchases and NFC purchases employ Virtual Financial Data Presentation (“VFDP”) to complete a purchase. That is, they allow a user to make purchases without presenting a merchant physical evidence of their financial information, such as a credit card or debit card.

To complete an online purchase using VFDP, a purchaser typically provides a significant amount of information to the merchant via the merchant's website. This information generally includes an account identifier (for example, credit card number, debit card number, etc.), shipping information, and the name, address, and contact information of the purchaser. It is becoming increasingly difficult for online shoppers to keep this information confidential and out of the possession of those who would use that information for fraudulent purposes. Once the financial information is stolen, the financial institution has limited means of determining whether subsequent online purchases are legitimate or fraudulent.

The growth of NFC purchases has added another potential avenue for financial information to be stolen. This technology allows purchasers to use their mobile device to communicate with a physical merchant's payment system. If a user's financial information is stolen, the thief can put the information into his own mobile device and fraudulently make purchases with that information. As the merchant does not require a physical credit card, the merchant has little cause to suspect and report a possible fraudulent purchase.

Further, the merchants themselves present a potential danger to a purchaser. Whether through negligence or intentional fraud, a merchant may submit erroneous transaction information to the financial institution. It is incumbent upon the purchaser to verify that the transaction amounts are consistent with the amounts agreed upon at the time of purchase. Many purchasers find this process burdensome and either neglect it or perform this check sporadically.

Thus, a need in the art exists for systems and methods that improve upon one or more of the above-described limitations.

### SUMMARY

An aspect of the present invention provides a computer-implemented method for protecting an online or NFC transaction from fraud. These VFDP transactions may utilize a financial account that is issued by a credit card issuer (“CCI”) or another similar financial institution. The purchaser installs a Fraud Prevention Application (“FPA”) on a device. This application recognizes that the purchaser is using his device to make a purchase using VFDP. The application initiates an independent connection with the CCI server. The FPA on the purchaser's device submits to the server verification data to validate the purchase. In response to this submission, the CCI server compares the data with identification data previously submitted by that purchaser's device and also with transaction data submitted by the merchant for the purchase. If the verification data is validated, then the CCI server approves the purchase and the transaction may proceed. If the verification data is not validated, then the CCI server refuses the transaction.

Another aspect of the present invention provides a computer program product that is installed on a user's device and on the server of a financial institution for protecting a VFDP transaction from fraud. The computer program product includes a non-transitory computer-readable storage device having computer-readable program instructions stored therein. The computer-readable program instructions include computer program instructions for recognizing that the user is using his device to make a purchase using VFDP; initiating an independent connection with a computer-readable program located on the CCI server; submitting to the server verification data to validate the purchase; comparing the data with identification data previously submitted by that user's device and also with transaction data submitted by the merchant; and approving the transaction when the verification data is validated and refusing the transaction when the verification data is not validated.

Another aspect of the present invention provides an apparatus for protecting an online or NFC transaction from fraud via a distributed network. The apparatus includes a web browser application with an FPA logically coupled to the web browser application. The FPA is configured to recognize that the user is employing his device to make a purchase using VFDP; initiate an independent connection with a computer-readable program located on the financial institution's server; submit to the server verification data to validate the purchase; compare the data with identification data previously submitted by that purchaser's device and also with transaction data submitted by the merchant; and approve the transaction when the verification data is validated and refuse the transaction when the verification data is not validated.

### BRIEF DESCRIPTION OF THE DRAWINGS

FIG. 1 is a block diagram depicting an operating environment of a FPA, in accordance with certain exemplary embodiments.

FIG. 2 is a block flow diagram depicting a method for using an FPA to protect an online purchase from fraud, in accordance with certain exemplary embodiments.

FIG. 3 is a block flow diagram depicting a method for using an FPA to protect a purchase made using NFC from fraud, in accordance with certain exemplary embodiments.

FIG. 4 is a block flow diagram depicting a method for using an FPA to protect an online purchase wherein the communication between the purchaser's device and the CCI server is an encrypted communication transmitted through the merchant's connection, in accordance with certain exemplary embodiments.

FIG. 5 is a block flow diagram depicting a method for using an FPA to protect a purchase made using NFC wherein the communication between the purchaser's device and the CCI server is an encrypted communication transmitted through the merchant's connection, in accordance with certain exemplary embodiments.

### DETAILED DESCRIPTION OF THE EXEMPLARY EMBODIMENTS

### Overview

The exemplary embodiments provide an application that can require a device to submit information to a CCI to have an online or NFC payment transaction approved. Users also can make purchases using VFDP and be protected from unscrupulous or negligent merchants. The FPA can be installed on the user's device, and the server of the CCI that provides the transaction approval can be configured to require the FPA submittal. The FPA can provide a user interface for entering configuration information to configure the FPA. The user can input into the FPA the financial account information that the system will protect. The financial account can be used by the device for VFDP transactions and may constitute a credit card account, debit card account, or any other electronic or online purchasing system. This account may be configured to be used only with this type of VFDP purchases. The CCI server can be configured to communicate with the FPA on the user's device when contacted by the device. When the FPA is installed on the user device, it may conduct an initial communication with the CCI server to establish a set of verification information required for device identity (for example, software version, browser identification, GPS location, registration information, user information, or other suitable information).

To complete an online purchase with a device employing the FPA, the user may visit an online merchant, select a product or products to purchase, and then navigate to the payment page of the website. The FPA on the device may recognize that the financial account is being used to make the online purchase and may initiate an independent communication with CCI server. The device FPA may furnish the CCI server with data to be used to verify the transaction is being requested by the user's device and not a fraudulent device. The CCI server may approve or refuse the purchase based on the verification of this data. The device FPA may additionally submit the transaction details to the CCI server. The CCI server may then compare the transaction details with the transaction details provided by the merchant. The CCI server may approve or refuse the purchase based on the verification of the accuracy of this data. The CCI server may alert the user's device that the merchant is submitting erroneous data either through negligence or intentional fraud. The user may then choose to abandon the purchase or to proceed with an alternate payment method.

To complete an NFC purchase with a mobile device employing the FPA, the user may visit a physical merchant location, select a product or products to purchase, and then approach the merchant's Point Of Sale (“POS”) terminal. The mobile device may communicate with the POS terminal via NFC technology or other applicable technologies (for example, BLUETOOTH, infrared, Wi-Fi, or other suitable communication technology). The device may submit the payment information to the POS terminal at the user's direction (for example, by swiping or “tapping” the device near the POS terminal, actuating a physical or virtual button, voicing a command, or other suitable input). The FPA on the mobile device may recognize that the financial account is being used to make an NFC purchase and may initiate an independent communication with CCI server. The device FPA may furnish the CCI server with identification data to be used to verify the transaction is being requested by the user's device and not a fraudulent device. The CCI server may approve or refuse the purchase based on the verification of this data. The device FPA may additionally submit the transaction details to the CCI server. The CCI server may then compare the transaction details with the transaction details provided by the merchant. The CCI server may approve or refuse the purchase based on the verification of this data. The CCI server may alert the user's device that the merchant is submitting erroneous data either through negligence or intentional fraud. The user may choose to abandon the purchase or proceed with an alternate payment method.

The FPA can be embodied as a stand-alone application program or as a companion program to a web browser, for example, as a companion program to a Hypertext Markup Language revision 5 (“HTML5”) compliant web browser or other type of web browser having messaging and storage capabilities. While certain embodiments are described in which parts of the FPA are implemented in software, it will be appreciated that one or more acts or functions of the FPA may be performed by hardware, software, or a combination thereof, as may be embodied in one or more computing systems.

The FPR can be utilized on the user device to facilitate multiple functions. For example, the FPR can record security information that identifies trusted merchants and non-trusted merchants based on the quantity of refused purchases. The FPA can use this security information to alert the user when he is providing financial account information or other information to non-trusted merchants. For example, the FPR may compare a merchant name, merchant website Uniform Resource Locator (URL), or Internet Protocol (IP) address to a list of known non-trusted merchants and alert the user accordingly.

Users may, in appropriate circumstances, limit or otherwise affect the operation of the features disclosed in this specification. For example, users may be given an initial opportunity to opt-in or opt-out of the collection or use of certain data or the activation of certain features. In addition, users may change the manner in which the features are employed, including for situations in which users may have concerns regarding their privacy. Instructions also may be provided to users to notify the users regarding policies about the use of information, including personally identifiable information and receipt information, and manners in which the users may affect such use of information.

### System Architecture

Turning now to the drawings, in which like numerals represent like (but not necessarily identical) elements throughout the figures, exemplary embodiments of the present invention are described in detail.

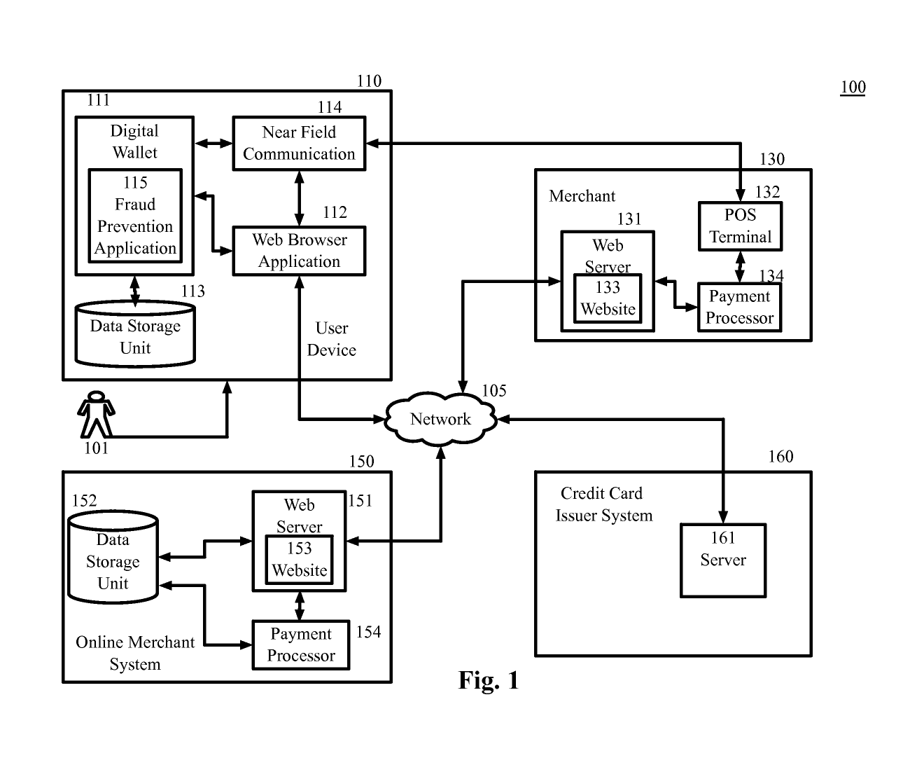

FIG. 1 is a block diagram depicting an operating environment 100 for a Fraud Prevention Application (“FPA”), in accordance with certain exemplary embodiments.

Referring to FIG. 1, the exemplary operating environment 100 includes a merchant system 130, an online merchant system 150, a credit card issuer system 160, and a user device 110 associated with a user 101.

The user device 110 may be a personal computer, mobile device, (for example, notebook computer, tablet computer, netbook computer, personal digital assistant (PDA), video game device, GPS locator device, cellular telephone, smartphone, or other mobile device), or other appropriate technology that includes or is coupled to a web browser application module 112, such as GOOGLE'S CHROME, MICROSOFT'S INTERNET EXPLORER®, or MOZILLA'S FIREFOX®.

In certain exemplary embodiments, the web browser application 112 is an HTML5 compliant web browser. HTML5 compliant web browsers include a cross-document messaging application programming interface (API) and a local storage API that previous HTML versions did not have. The cross-document messaging API of an HTML5 compliant web browsers enables documents, such as web pages, to communicate with each other. For example, a first document can send a message to a second document requesting information. In response, the second document can send a message including the requested information to the first document. The local storage API of HTML5 compliant web browsers enables the web browser to store information on a client device upon which the web browser is installed or is executing, such as the user device 110. Websites also can employ the local storage API to store information on a client device. Other web browsers having cross-document messaging and/or local storage capabilities also may be used in certain exemplary embodiments.

The user 101 can use the web browser application 112 to view, download, upload, or otherwise access documents or web pages via a distributed network 105. The network 105 includes a wired or wireless telecommunication system or device by which network devices (including devices 110, 130, 150, and 160) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages. Throughout the discussion of exemplary embodiments, it should be understood that the terms “data” and “information” are used interchangeably herein to refer to text, images, audio, video, or any other form of information that can exist in a computer based environment.

The web browser application 112 can interact with web servers (or other computing devices) connected to the network 105, such as web server 131 of the merchant system 130, web server 151 of the online merchant environment 150, and CCI server 161 of the CCI system 160.

The user device 110 may also include a digital wallet application module 111. The digital wallet 111 may encompass any application, hardware, software, or process the user device 110 may employ to assist the device to complete a VFDP purchase. The digital wallet 111 can interact with the web browser application 112 or can be embodied as a companion application of the web browser application 112. As a companion application, the digital wallet 111 executes within the web browser application 112. That is, the digital wallet 111 may be an application program embedded in the web browser application 112.

The user device 110 can include an FPA 115. The FPA 115 can interact with the web browser application 112 or be embodied as a companion application of the web browser application 112 and execute within the web browser application 112. The FPA may further be embodied as a companion application of the digital wallet 111 and execute within the digital wallet 111. The FPA 115 may employ a software interface that may open in the digital wallet application 111 or may open in the web browser application 112. This interface can allow the user 101 to select the financial account or accounts to which the FPA 115 will be attached and thus will monitor for VFDP purchases. This interface also can allow the user 101 to select the verification data to be used when validating a purchase.

The user device 110 also includes a data storage unit 113 accessible by the digital wallet 111 and the web browser application 112. The exemplary data storage unit 113 can include one or more tangible computer-readable media. The data storage unit 113 can be stored on the user device 110 or can be logically coupled to the user device 110. For example, the data storage unit 113 can include on-board flash memory and/or one or more removable memory cards or removable flash memory.

The user device 110 also includes an NFC communication module 114 that may be accessible by the FPA 115, digital wallet 111, and the web browser application 112. The NFC module 114 may be utilized at a physical merchant 130 environment when a user 101 indicates a desire to purchase one or more products. As used throughout the specification, the term “products” should be interpreted to include tangible and intangible products, as well as services. After the user 101 has indicated a desire to purchase the product(s), the merchant system 130 can present a user interface in the form of a POS terminal 132 to receive payment information from the user 101. The NFC communication module 114 can interact with the POS terminal 132 within the merchant environment 130 to allow the digital wallet 111 to complete the sale. The NFC communication module 114 can employ any of the available technologies to communicate to the POS terminal 132. Technologies available for communication may include, but are not limited to, NFC, BLUETOOTH, wireless communication, and infrared. The NFC communication module 114 may encompass the software and hardware capacity required for communicating in the selected manner with the POS terminal 132.

The merchant system 130 includes a payment processor 132 logically coupled to the web server 131. The payment processor 132 can receive payment information via the POS terminal 132 and interact with the CCI server 161 to authorize payment information.

The CCI server 161 is implemented in the CCI system 160. This CCI server 161 represents the computer-implemented system that the CCI system 160 employs to process the financial account functions of their financial clients. The CCI server 161 can communicate with online merchant systems 150, physical merchants 130, and user devices 110 via any suitable communication technologies. These technologies may include, but would not be limited to, an Internet connection via the network 105, email, text, instant messaging, or any other suitable technology.

The FPA 115 may recognize that the NFC communication module 114 is making a purchase using the financial account to which the FPA 115 is attached and establish an independent communication with the CCI server 161 via the network 105. The FPA can transmit the verification data to the CCI server 161 which may validate the data. Based on the outcome of the validation, the CCI server 161 may approve or refuse the transaction with the merchant 130.

The payment option(s) stored in the digital wallet 111 can be used to complete online purchases from merchants via an online merchant's website 153 operating on the web server 151. Each merchant's website 153 (operating on the web server 151) that accepts payment via a digital wallet 111 can include a set of computer-readable program instructions, for example, using JavaScript, that enable the merchant's website 153 to interact with the digital wallet 111 to supply the financial information to complete the purchase. To complete an online purchase, the digital wallet 111 can interact with a website 153 of the online merchant system 150 and with the user 101. The user 101 can browse the online merchant's website 153 for products using the web browser 112 and indicate a desire to purchase one or more products. After the user 101 has indicated a desire to purchase the product(s) (for example, by actuating a “checkout” link), the online merchant's website 153 can present a user interface in the form of a web page to receive payment information from the user 101.

The online merchant's website 153 and the digital wallet 111 can communicate using a defined messaging protocol. The digital wallet 111 can encode a message using the protocol and send the encoded message to the online merchant's website 153, where the message is decoded using the protocol. Similarly, the online merchant's website 153 can encode a message using the protocol and send the encoded message to the digital wallet 111 where the message is decoded using the protocol. The online merchant system 150 includes a payment processor 154 logically coupled to the web server 151. The payment processor 154 can receive payment information via the web server 151 and interact with the CCI server 161 to authorize payment information.

The FPA 115 may recognize that the digital wallet 112 is making a purchase using the financial account to which the FPA 115 is attached and establish an independent communication with the CCI server 161 via the network 105. The FPA can transmit the verification data to the CCI server 161 which may validate the data. Based on the outcome of the validation, the CCI server 161 may approve or refuse the transaction with the online merchant 150.

It will be appreciated that the network connections shown are exemplary and other means of establishing a communications link between the computers and devices can be used. Moreover, those having ordinary skill in the art having the benefit of the present disclosure will appreciate that the merchant system 130, online merchant system 150, CCI system 160, and the user device 110 illustrated in FIG. 1 can have any of several other suitable computer system configurations. For example a user device 110 embodied as a mobile phone or handheld computer may not include all the components described above.

### System Process

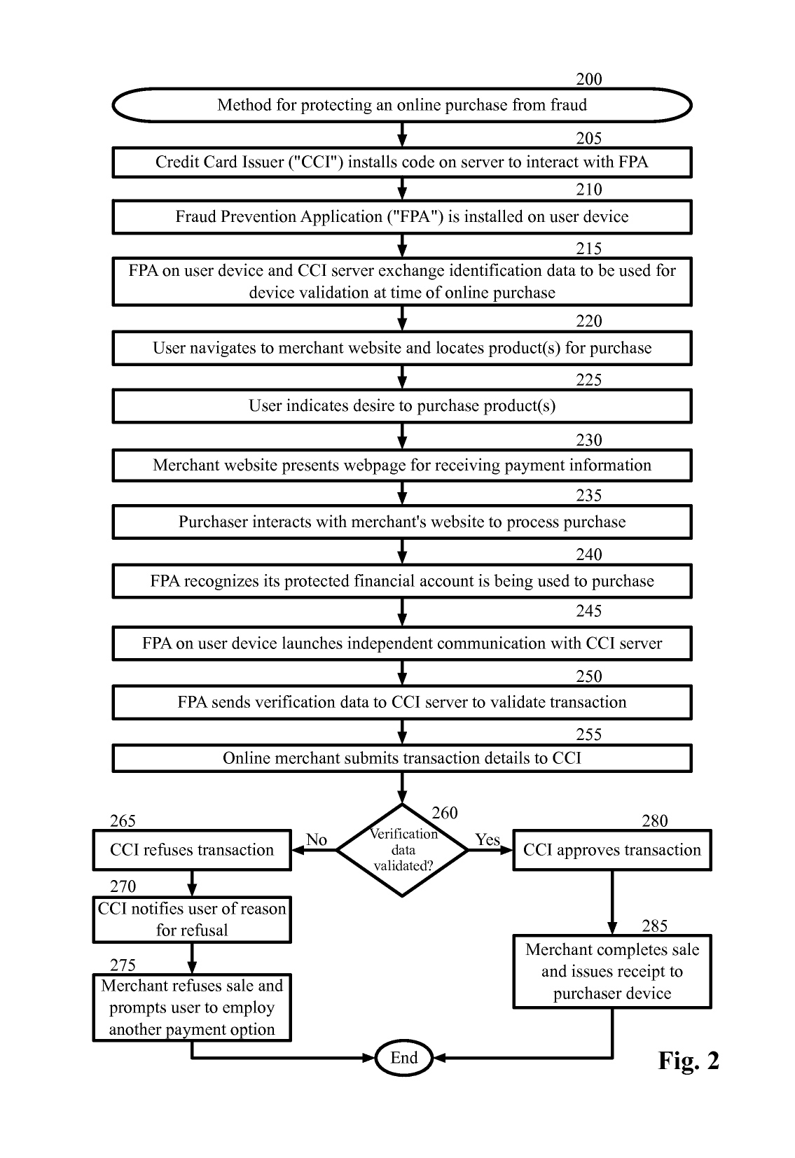

The components of the exemplary operating environment 100 are described hereinafter with reference to the exemplary methods illustrated in FIGS. 2-5. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 2 is a flow chart depicting a method 200 for completing an online purchase using an FPA 115, in accordance with certain exemplary embodiments. With reference to FIGS. 1 and 2, in block 205, the CCI system 160 installs computer-readable program instructions on the CCI server 161 for interacting with the FPA 115 on the user device 110. In an exemplary embodiment, these computer-readable program instructions can be implemented as an embedded script, such as JavaScript, in the CCI server 161.

In block 210, the FPA 115 is installed on the user device 110. In certain exemplary embodiments, the user 101 can navigate to a website 153 of a provider of the FPA 115 and download and install the FPA 115. The FPA 115 may be embedded in a digital wallet 112 on a user device 110. The user 101 may employ a user interface of the FPA 115 to assign a financial account for the FPA to monitor and protect. This financial account may include or be associated with any type payment option, such as a credit card account, a debit card account, a checking account, a savings account, a loyalty rewards account, or other type of account that can be used to make a purchase. The FPA 115 may be attached to one or more financial accounts and will interact with the CCI system 160 that is associated with that financial account when required.

In block 215, the user 101 navigates to the CCI server 161 using the web browser application 112 and communicates with the computer-readable program instructions on the CCI server 161. The user 101 may select and submit the verification data that they choose to have validated when making a VFDP purchase. The CCI server 161 may access verification data from the device to establish an initial verification standard. One skilled in the art would recognize that there are numerous device-specific identifiers that may be employed to verify a device. These identifiers may include, but would certainly not be limited to, device model, software versions, browser identification, GPS location, registration information, or other suitable information.

In block 220, the user 101 browses the online merchant's website 153 for one or more products to purchase and makes a selection for purchase. In block 225, the user 101 indicates a desire to purchase one or more products. For example, the user 101 may browse the online merchant's website 153 and add products to a virtual shopping cart. Once the user 101 is ready to checkout, the user 101 can actuate a “checkout” link on the merchant's website 153.

In block 230, the online merchant's website 153 presents a web page via the web browser application 112 for obtaining payment information from the user 101. This web page can include conventional payment options, such as a form for receiving payment information and contact information and/or a link to a third party payment processor. This web page also can include the computer-readable program instructions for detecting and interacting with a digital wallet 111. Purchase details supplied by the online merchant's website 153 may include the purchase price of the products, the identity of the products, the applicable taxes, the total charges, merchant name, merchant location, and other transaction information.

In block 235, the online merchant's website 153 interacts with the digital wallet 111 to complete the purchase of the products selected by the user 101. The online merchant's website 153 can attach to the digital wallet 111 and send a purchase request message to the digital wallet 111. In response to receiving the purchase request message, the digital wallet 111 can present a user interface to the user 101 for the user 101 to confirm the purchase. The user interface also can allow the user 101 to select from multiple payment options to send to the online merchant's website 153. If the user 101 confirms the purchase, the digital wallet 111 sends a merchant request message including the confirmation and payment information associated with the payment option to the online merchant's website 153. The payment processor 154 may interact with the CCI server 161 associated with the payment information to obtain authorization of the purchase.

In block 240, the FPA 115 on the user device may recognize that the financial account selected to make the online payment is a financial account that the FPA 115 is monitoring and protecting. For example, the FPA may monitor communications of the digital wallet 111, identify the financial account information that is provided by the digital wallet 111 to the POS terminal 132, and compare the financial account information with the configured financial accounts that are monitored by the FPA. In an alternative exemplary embodiment, the digital wallet 111 may communicate the financial account information to the FPA each time the digital wallet 111 conducts a financial transaction. Additionally, in certain exemplary embodiments, the FPA may act for any financial account used by the digital wallet 111.

In block 245, the FPA 115 initiates an independent communication with the CCI server through the network 105. One skilled in the art will recognize that the FPA 115 may employ any of a number of communication channels to establish this connection including an Internet connection through the web browser application and the network 105, a cellular connection, text, email, or any other communication channel capable of submitting the verification data.

In block 250, the FPA 115 sends the verification data to the CCI server 161. The verification data may include the device identifiers discussed above with reference to block 215. Additionally or alternatively, the verification data may include transaction data from the purchase transaction. The transaction data may include, but would not be limited to, the purchase price of the products, the identity of the products, the applicable taxes, the total charges, merchant name, merchant location, and other transaction information.

In block 255, the online merchant system 150 transmits the transaction details to the CCI system 160 that issued the financial account to seek approval for the purchase. The transaction details submitted by the online merchant system 150 may include the financial data provided by the digital wallet 111, such as financial account identifier, an expiration date of a card associated with the financial account, billing address of the user, and shipping address of the user; and the transaction data provided by the online merchant's website 153, such as the transaction data identified previously with reference to block 230.

In block 260, the CCI server validates the verification data provided by the user device 110 to determine whether to authorize the transaction received from the online merchant's website 153. If the verification data is validated, the method 200 follows the “YES” branch to block 280. Otherwise, the method 200 follows the “NO” branch to block 265.

The CCI server 161 may be directed by the computer-readable program instructions stored thereon to analyze the identification data supplied by the FPA 115 in the verification data and to compare the identification the data to the previously supplied identification data. Alternatively or additionally, the CCI server 161 may compare the transaction data supplied by the FPA 115 in the verification data to the transaction data supplied by the online merchant system 150. If the specified portion of the verification information matches the previously provided identification information and/or the merchant provided transaction data, then the CCI server validates the purchase transaction.

If the CCI server 161 validates all of the data that is required by the configuration, then the method 200 follows the “YES” branch of block 260 to block 265. If the CCI server 161 recognizes that the identification data and/or the transaction data do not match the expected values, then the method 200 follows the “NO” branch to block 280.

Following the “NO” branch of block 260 to block 265, the CCI server 161 may refuse the transaction and respond to the online merchant system 150 that the transaction is refused and authorization is not granted. In block 270, the CCI server 161 may further alert the user 101 of the reason the transaction was refused. This alert may be transmitted via any available communication technology including, but certainly not limited to, email, text, instant messaging, web browser alerts, etc.

In block 275, the online merchant system 150, upon receipt of the transaction refusal, may cancel the transaction with the user 101 and prompt the user 101 to employ another payment option.

Following the “YES” branch of block 260 to block 280, the CCI server 161 validates all of the verification data supplied by the user 101 and the online merchant system 150 and authorizes the transaction. The CCI 161 alerts the online merchant system 150 that the purchase is authorized. In block 285, the online merchant system 160 completes the transaction with the user 101 and issues a receipt to the user device 110.

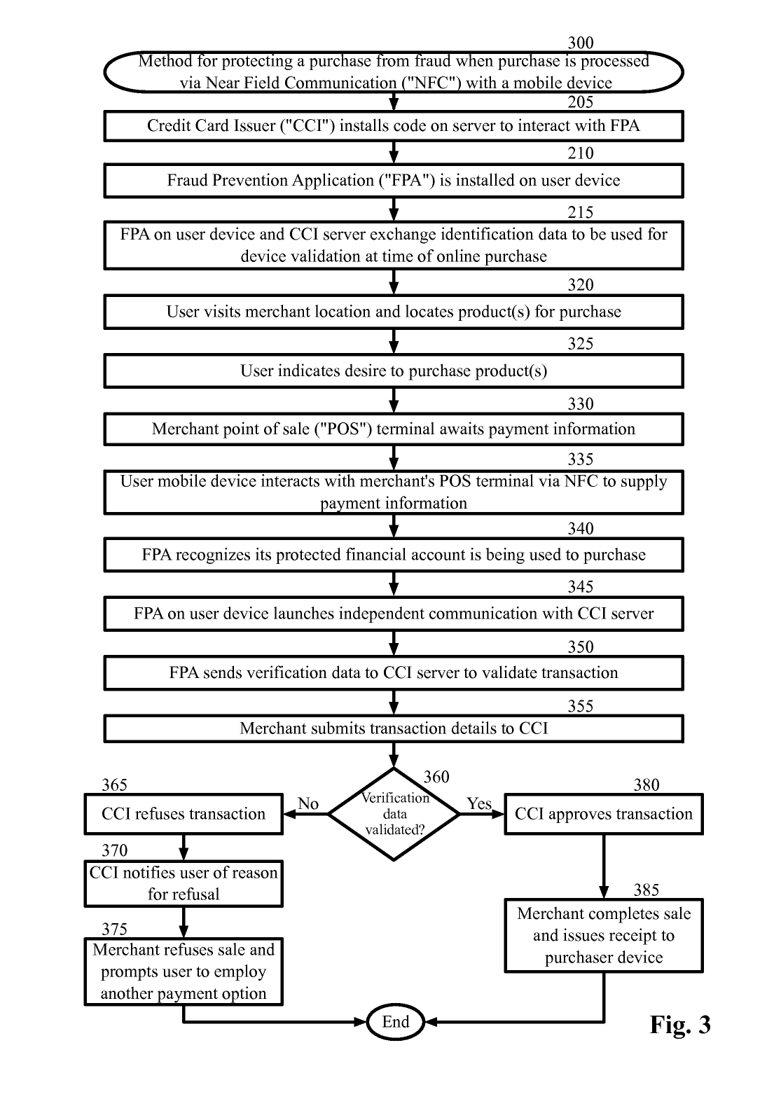

FIG. 3 is a flow chart depicting a method 300 for completing an NFC purchase using an FPA 115, in accordance with certain exemplary embodiments. As referenced in FIG. 2, in block 205 the CCI system 160 installs computer-readable program instructions on the CCI server 161 for interacting with the FPA 115 on the user device 110. In an exemplary embodiment, these computer-readable program instructions can be implemented as an embedded script, such as JavaScript, in the CCI server 161.

In block 210, the FPA 115 is installed on the user device 110, as referenced in FIG. 2. In certain exemplary embodiments, the user 101 can navigate to a website 153 of a provider of the FPA 115 and download and install the FPA 115. The FPA 115 may be embedded in a digital wallet 112 on a user device 110. The user 101 may employ a user interface of the FPA 115 to assign a financial account for the FPA to monitor and protect. This financial account may include or be associated with any type payment option, such as a credit card account, a debit card account, a checking account, a savings account, a loyalty rewards account, or other type of account that can be used to make a purchase. The FPA 115 may be attached to one or more financial accounts and will interact with the CCI system 160 that is associated with that financial account when required.

In block 215, the user 101 navigates to the CCI server 161 using the web browser application 112 and communicates with the computer-readable program instructions on the CCI server 161, as referenced in FIG. 2. The user 101 may select and submit the verification data that they choose to have validated when making a VFDP purchase. The CCI server 161 may access verification data from the device to establish an initial verification standard. One skilled in the art would recognize that there are numerous device-specific identifiers that may be employed to verify a device. These identifiers may include, but would certainly not be limited to, device model, software versions, browser identification, GPS location, registration information, or other suitable information.

In block 320, the user 101 browses the location of the merchant 130 for one or more products to purchase and makes a selection for purchase. This merchant 130 location may be a physical store or marketplace. In block 325, the user 101 indicates a desire to purchase one or more products. For example, the user 101 may select a product or products of the merchant 130 and take the product(s) to the POS terminal 132 for checkout.

In block 330, the merchant 130 inputs the purchase details into the POS terminal 132. This may include the purchase price of the products, the identity of the products, the applicable taxes, the total charges, merchant name, merchant location, and other transaction information. The POS terminal awaits payment information from the user 101.

In block 335, the user 101 employs the user device 110 to interact with the POS terminal 132 via NFC to supply payment information. One skilled in the art would recognize that the NFC communication module 114 on the user device 110 may employ any of the available technologies to communicate to the POS terminal 132. Technologies available for communication may include, but would certainly not be limited to, NFC, BLUETOOTH, wireless communication, and infrared. The NFC communication, and the supplying of financial account information to the POS terminal 132, may be initiated by the user 101 in any manner accepted by the user device 110. This action may include depressing a physical or virtual button, a gesture or swipe of the device, a voice command, or other suitable action.

In an exemplary embodiment, when the user moves the device 110 within range of the POS terminal 132, the POS terminal 132 and the device 110 establish a communication channel. Then, the POS terminal 132 requests payment from the digital wallet 111 on the device 110. In response, the digital wallet 111 communicates the payment information from the user device 110 to the POS terminal 130.

In block 340, the FPA 115 on the user device 110 may recognize that the financial account selected to make the NFC payment is a financial account that the FPA 115 is monitoring and protecting. For example, the FPA may monitor communications of the digital wallet 111, identify the financial account information that is provided by the digital wallet 111 to the POS terminal 132, and compare the financial account information with the configured financial accounts that are monitored by the FPA. In an alternative exemplary embodiment, the digital wallet 111 may communicate the financial account information to the FPA each time the digital wallet 111 conducts a financial transaction. Additionally, in certain exemplary embodiments, the FPA may act for any financial account used by the digital wallet 111.

In block 345, the FPA 115 initiates an independent communication with the CCI server through the network 105. One skilled in the art will recognize that the FPA 115 may employ any of a number of communication channels to establish this connection including an Internet connection through the web browser application 112 and the network 105, a cellular connection, text, email, or any other communication channel capable of submitting the verification data.

In block 350, the FPA 115 sends the verification data to the CCI server 161. The verification data may include the device identifiers discussed above with reference to block 215. Additionally or alternatively, the verification data may include transaction data from the purchase transaction via the POS terminal. The transaction data may include, but would not be limited to, the purchase price of the products, the identity of the products, the applicable taxes, the total charges, merchant name, merchant location, and other transaction information

In block 355, the merchant 130 transmits the transaction details obtained by the POS terminal 132 to the CCI system 160 that issued the financial account to seek approval for the purchase. The transaction details submitted by the merchant 130 may include the financial data provided by the digital wallet 111, such as financial account identifier, an expiration date of a card associated with the financial account, billing address of the user, and shipping address of the user; and the transaction data provided by the POS system, such as the transaction data identified previously with reference to block 330.

In block 360, the CCI server validates the verification data provided by the user device 110 to determine whether to authorize the transaction received from the POS terminal 132. If the verification data is validated, the method 300 follows the “YES” branch to block 380. Otherwise, the method 300 follows the “NO” branch to block 365.

The CCI server 161 may be directed by the computer-readable program instructions stored thereon to analyze the identification data supplied by the FPA 115 in the verification data and to compare the identification data to the previously supplied identification data. Alternatively or additionally, the CCI server 161 may compare the transaction data supplied by the FPA 115 in the verification data and to the transaction data supplied by the merchant 130. If the specified portion of the verification information matches the previously provided identification information and/or the merchant provided transaction data, then the CCI server validates the purchase transaction.

If the CCI server 161 validates all of the data that is required by the configuration, then the method 300 follows the “YES” branch of block 360 to block 365. If the CCI server 161 recognizes that the identification data and/or the transaction data do not match the expected values, then the method 200 follows the “NO” branch to block 280.

Following the “NO” branch of block 360 to block 365, the CCI server 161 may refuse the transaction and respond to the merchant 130 that the transaction is refused and authorization is not granted. In block 370, the CCI server 161 may further alert the user 101 of the reason the transaction was refused. This alert may be transmitted via any available communication technology including, but certainly not limited to, email, text, instant messaging, web browser alerts, etc.

In block 375, the merchant 130, upon receipt of the transaction refusal, may cancel the transaction with the user 101 and prompt the user 101 to employ another payment option.

Following the “YES” branch of block 360 to block 380, the CCI server 161 validates all of the verification data supplied by the user 101 and the merchant 130 and authorizes the transaction. The CCI 161 alerts the merchant 130 that the purchase is authorized. In block 385, the merchant 130 completes the transaction with the user 101 and issues a receipt to the user 101 or the user device 110.

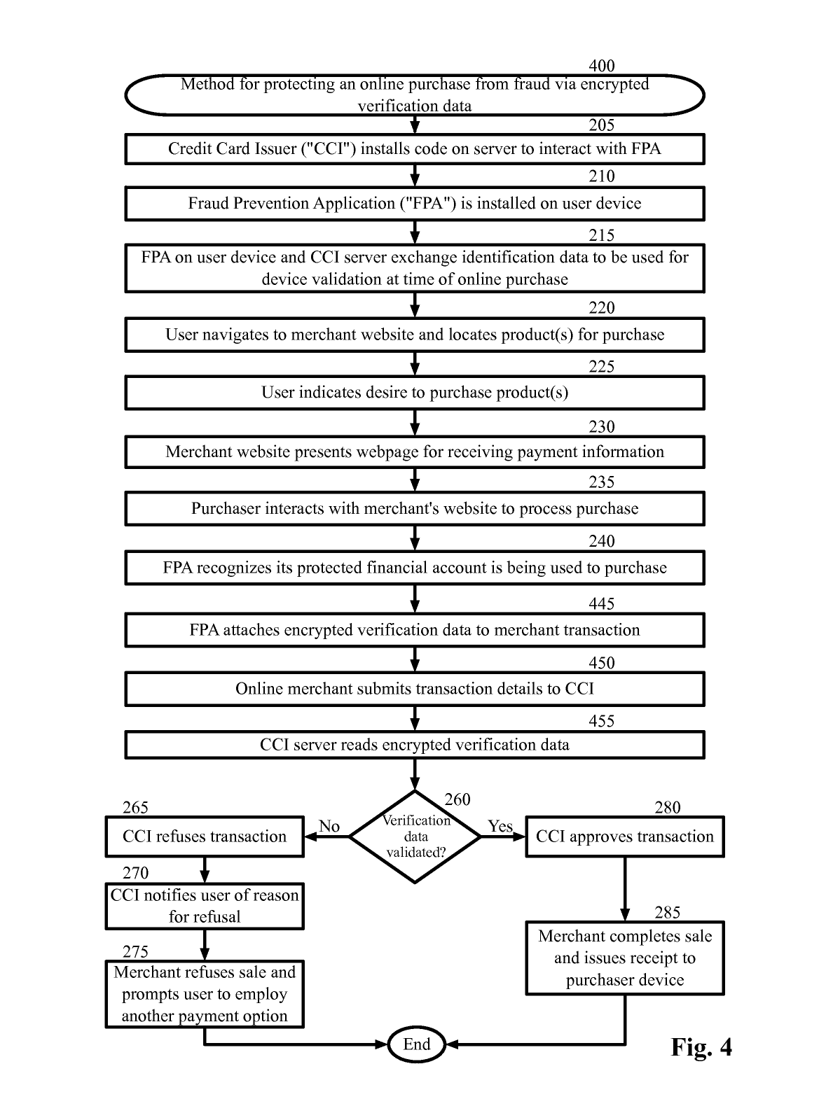

FIG. 4 is a flow chart depicting a method 400 for completing an online purchase using an FPA 115 via an encrypted verification bundle attached to the online merchant 150 transaction data, in accordance with certain exemplary embodiments. In block 405 the CCI system 160 installs computer-readable program instructions on the CCI server 161 for interacting with the FPA 115 on the user device 110. In an exemplary embodiment, these computer-readable program instructions can be implemented as an embedded script, such as JavaScript, in the CCI server 161. The instructions may be particularly configured to locate and interpret encrypted data transmitted from the FPA 115.

Method 400 has many similar elements to method 200. Block 210 through block 240 of method 400 are substantially similar to the like-numbered blocks 210 through 240 of method 200, referenced in FIG. 2 and described above.

Referring back to FIG. 2, in block 245 of method 200, the FPA 115 launches an independent communication with the CCI server 161. In block 445 of method 400, the FPA 115 instead produces an encrypted data package of verification data and attaches it logically to the transaction data being submitted to the CCI server 161 by the online merchant system 150. The verification data may include the device identifiers discussed above in block 215 of FIG. 2. The verification data may also include the transaction data from the purchase. The transaction data may include, but would not be limited to, the purchase price of the products, the identity of the products, the applicable taxes, the total charges, merchant name, merchant location, and other transaction information. In the exemplary embodiment, the online merchant 150 may be incapable of decrypting and reading the verification data.

In block 450, the online merchant system 150 transmits the transaction details to the CCI system 160 that issued the financial account to seek approval for the purchase. The transaction details submitted by the online merchant system 150 may include the financial data provided by the digital wallet 111, such as financial account identifier, an expiration date of a card associated with the financial account, billing address of the user, and shipping address of the user; and the transaction data provided by the online merchant system 150, such as the transaction data identified previously with reference to block 230 of FIG. 2. The encrypted verification data produced by the FPA 115 may be logically attached to the transmission submitted by the online merchant system 150.

In block 455, the CCI server 161 receives the transmission and request for authorization from the online merchant system 150. The CCI server 161 may be directed by the computer-readable program instructions to recognize and decrypt the verification data logically attached to the transmission from the online merchant system 150.

Block 260 through block 285 of method 400 are substantially similar to the like-numbered blocks 260 through 285 of method 200, referenced in FIG. 2 and described above.

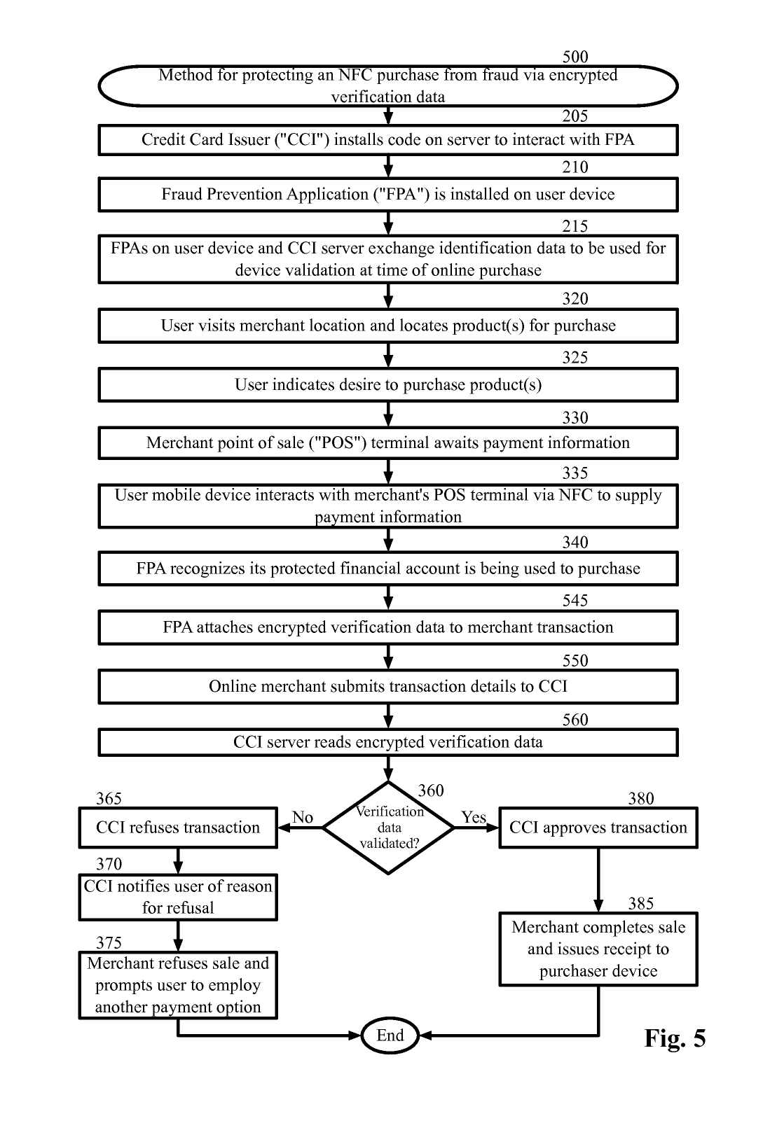

FIG. 5 is a flow chart depicting a method 500 for completing an NFC purchase using an FPA 115 via an encrypted verification bundle attached to the merchant 130 transaction data, in accordance with certain exemplary embodiments. In block 505 the CCI system 160 installs computer-readable program instructions on the CCI server 161 for interacting with the FPA 115 on the user device 110. In an exemplary embodiment, these computer-readable program instructions can be implemented as an embedded script, such as JavaScript, in the CCI server 161. The instructions may be particularly configured to locate and interpret encrypted data transmitted from the FPA 115.

Method 500 has many similar elements to method 300. Block 210 through block 340 of method 500 are substantially similar to like-numbered blocks 210 through 340 of method 300, referenced in FIG. 3 and described above.

Referring back to FIG. 3, in block 345 of method 300, the FPA 115 launches an independent communication with the CCI server 161. In block 445 of method 400, the FPA 115 instead produces an encrypted data package of verification data and attaches it logically to the transaction data being submitted to the CCI server 161 by the merchant system 130. The verification data may include the device identifiers discussed above in block 215 of FIG. 3. The verification data may also include the transaction data from the purchase. The transaction data may include, but would not be limited to, the purchase price of the products, the identity of the products, the applicable taxes, the total charges, merchant name, merchant location, and other transaction information. In the exemplary embodiment, the merchant 130 may be incapable of decrypting and reading the verification data.

In block 550, the merchant system 130 transmits the transaction details to the CCI system 160 that issued the financial account to seek approval for the purchase. The transaction details submitted by the online merchant system 150 may include the financial data provided by the digital wallet 111, such as financial account identifier, an expiration date of a card associated with the financial account, billing address of the user, and shipping address of the user; and the transaction data provided by the POS terminal 132, such as the transaction data identified previously with reference to block 330 of FIG. 3. The encrypted verification data produced by the FPA 115 may be logically attached to the transmission submitted by the merchant 130.

In block 555, the CCI server 161 receives the transmission and request for authorization from the merchant 130. The CCI server 161 may be directed by the computer-readable program instructions to recognize and decrypt the verification data logically attached to the transmission from the merchant 130.

Block 360 through block 385 of method 500 are substantially similar to like-numbered blocks 360 through 385 of method 300, referenced in FIG. 3 and described above.

### General

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act. The inventive functionality of the invention will be explained in more detail in the following description, read in conjunction with the figures illustrating the program flow.

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for protecting a virtual financial data presentation (“VFDP”) transaction from fraud, comprising:
communicating, by a user network device to a network device operated by a credit card issuer (“CCI”), initial verification information for future transactions conducted using a designated financial account operated by the CCI network device;
storing, by the user network device, the initial verification information;
recognizing, by the user network device, the user network device conducting a VFDP transaction with a merchant using the designated financial account operated by the CCI network device;
communicating, by the user network device to a network device of the merchant, information to conduct the VFDP transaction via the merchant network device, the information to conduct the VFDP transaction comprising information identifying the designated financial account operated by the CCI network device;
communicating, by the user network device to the CCI network device, transaction verification data comprising at least a portion of the initial verification data, in response to recognizing, by the user network device, the user network device conducting the VFDP transaction with a merchant using the designated financial account operated by the CCI network device; and
receiving, by the user network device, notification from the merchant network device for the VFDP transaction, the notification based on a match between the transaction verification data and a corresponding portion of the initial verification data previously communicated to the CCI network device.

2. The method of claim 1, wherein the user network device comprises a mobile device.

3. The method of claim 1, wherein the initial verification data and the transaction verification data each comprise a device identifier for the user network device.

4. The method of claim 1, wherein the VFDP transaction is an online purchase, and wherein the user network device communicates the information to conduct the VFDP transaction to the merchant network device via a website of the merchant network device.

5. The method of claim 1, wherein the VFDP transaction is a near field communication (“NFC”) purchase, and wherein the user network device communicates the information to conduct the VFDP transaction to the merchant network device via NFC.

6. The method of claim 1, wherein the communication by the user network device with the CCI network device is conducted via a communication channel independent from a communication channel with the merchant network device.

7. A computer-implemented method for protecting a virtual financial data presentation (“VFDP”) transaction from fraud, comprising:
receiving, by a computer, initial verification information for an account accessible by the computer;
receiving, by the computer from a merchant network device, a request for authorization of the VFDP transaction, the request comprising information regarding the VFDP transaction;
receiving, by the computer from a user network device, transaction verification data comprising at least a portion of the initial verification data;
determining, by the computer, whether the transaction verification data matches at least a portion of the initial verification data; and
authorizing, by the computer, the VFDP transaction in response to a determination that the transaction verification data matches at least a portion of the initial verification data.

8. The method of claim 7, wherein the transaction verification data further comprises at least a portion of the information regarding the VFDP transaction,
wherein the determining step comprises determining whether the transaction verification data matches at least a portion of the initial verification data and at least a portion of the request, and
wherein the authorizing step comprises authorizing the VFDP transaction in response to a determination that the transaction verification data matches at least a portion of the initial verification data and at least a portion of the request.

9. The method of claim 7, wherein the VFDP transaction is an online purchase.

10. The method of claim 7, wherein the VFDP transaction is a near field communication purchase.

11. The method of claim 7, wherein the computer receives the transaction verification data from the user network device via a communication channel that is independent from a communication channel via which the computer receives the request from the merchant network device.

12. The method of claim 7, wherein the computer receives the transaction verification data from the user network device as an encrypted data bundle, readable only by the computer, logically attached to the request received from the merchant network device.

13. A computer program product for protecting a virtual financial data presentation (“VFDP”) transaction from fraud, the computer program product comprising:
a non-transitory computer-readable storage device having computer-readable program instructions stored therein, the computer-readable program instructions comprising:
computer-readable program code to receive initial verification information for an account accessible by a computer;
computer-readable program code to receive from a merchant network device a request for authorization of the VFDP transaction, the request comprising information regarding the VFDP transaction;
computer-readable program code to receive from a user network device transaction verification data comprising at least a portion of the initial verification data;
computer-readable program code to determine whether the transaction verification data matches at least a portion of the initial verification data; and
computer-readable program code to authorize the VFDP transaction in response to a determination that the transaction verification data matches at least a portion of the initial verification data.

14. The computer program product of claim 13, wherein the transaction verification data further comprises at least a portion of the information regarding the VFDP transaction,
wherein the computer-readable program code to determine comprises computer-readable program code to determine whether the transaction verification data matches at least a portion of the initial verification data and at least a portion of the request, and
wherein the computer-readable program code to authorize comprises computer-readable program code to authorize the VFDP transaction in response to a determination that the transaction verification data matches at least a portion of the initial verification data and at least a portion of the request.

15. The computer program product of claim 13, wherein the VFDP transaction is an online purchase.

16. The computer program product of claim 13, wherein the VFDP transaction is a near field communication purchase.

17. The computer program product of claim 13, wherein the transaction verification data from the user network device is received via a communication channel that is independent from a communication channel via which the computer receives the request from the merchant network device.

18. The computer program product of claim 13, wherein the transaction verification data from the user network device is received as an encrypted data bundle, readable only by the computer, logically attached to the request received from the merchant network device.

19. A system for protecting a virtual financial data presentation (“VFDP”) transaction from fraud via a distributed network, the system comprising:
a user network device; and
a credit card issuer (“CCI”) network device,
the user network device comprising a processor, a web browser application, and a fraud protection application (“FPA”) logically coupled to the web browser application, the FPA application configured to:
transmit identification data to the CCI network device for an initial identification configuration stored at the CCI network device;
recognize an attempt to conduct a VFDP transaction using a designated financial account operated by the CCI network device; and
communicate with the CCI network device to provide transaction verification data for the VFDP transaction to the CCI network device, and
the CCI network device comprising a processor and a CCI application executing therein, the CCI application configured to:
store the identification data received from the user network device;
compare the transaction verification data provided by the user network device with the stored identification data and VFDP transaction data received from a merchant network device for the VFDP transaction, wherein the VFDP transaction data received from the merchant network device comprises information to conduct the VFDP transaction; and
authorize the VFDP transaction in response to determining that the transaction verification data matches at least a portion of the stored verification data.

20. The system of claim 19, wherein the FPA module is embedded in the web browser application.

21. The system of claim 19, wherein user network device further comprises a digital wallet application, and wherein the FPA module executes within the digital wallet application.

22. The system of claim 19, wherein the verification data provided by the user network device comprises at least one or more device identifiers and transaction particulars.

23. The system of claim 19, wherein the VFDP transaction is an online purchase conducted via the browser application of the user network device.

24. The system of claim 19, wherein the VFDP transaction is a near field communication (“NFC”) purchase.

25. The system of claim 19, wherein the communication by the user network device with the CCI network device is comprised of a communication channel that is independent from a communication channel via which the CCI network device receives the VFDP transaction information from the merchant network device.

26. The system of claim 19, wherein the communication by the user network device with the CCI network device comprises an encrypted data bundle, readable only by the CCI network device, that is logically attached to VFDP transaction information received by the CCI network device from the merchant network device.
